(19) United States
(12) Patent Application Publication
(10) Pub. No.: US 2005/0182912 A1
(43) Pub. Date: Aug. 18, 2005

(54) Method of effective to real address translation for a multi-threaded microprocessor

(75) Inventors: Jonathan James DeMent, Austin, TX (US); Kimberly Marie Fernsler, Round Rock, TX (US); Cathy May, Millwood, NY (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/777,906

(22) Filed: Feb. 12, 2004

(51) Int. Cl. G06F 12/08

(52) U.S. Cl. 711/206; 711/207; 711/144

(57) ABSTRACT

The present invention provides a method and apparatus for efficiently translating an effective address (EA) to a real address (RA) in an Effective to Real Address Translation (ERAT) table, in a main processing unit (MPU) having two or more threads. A thread, using an EA, presents the EA for lookup in the ERAT table. The EA is compared to each entry in the ERAT table. If (i) the EA matches an entry in the ERAT table, (ii) a valid indicator in the matching entry indicates it is valid for other threads but not valid for the thread presenting the EA for lookup, and (iii) the information in the matching entry is correct for the EA presented for lookup, then the valid indicator is set to show that the matching entry is valid for the thread presenting the EA for lookup, in addition to the other threads.

### FIELD OF THE INVENTION

The invention relates generally to multi-threaded processors and, more particularly, to Effective to Real Address Translation (ERAT).

### BACKGROUND OF THE INVENTION

Modern multi-threaded processors partition memory into segments. By using virtual memory, where portions of memory are swapped from hard disk to main memory, the sum of all memory segments can be greater than the actual amount of memory present. A thread, which is one instance of a software program, can have more than one memory segment assigned to it. Two or more threads can share a memory segment. Each thread addresses its memory segment using an effective address (EA), as the thread is unaware of the real address in memory. The effective address is translated to a real address (RA) using an Effective to Real Address Translation (ERAT) table.

TABLE 1

| Valid Indicator | Thread Identifier | Meaning |
|---|---|---|
| 0 | 0 | Not valid |
| 1 | 0 | Valid for thread 0 only |
| 0 | 1 | Not valid |
| 1 | 1 | Valid for thread 1 only |

In the conventional technology, each entry in the ERAT table has an EA and associated pieces of information, including a valid indicator and a thread identifier. For a dual-thread system, the valid indicator, thread identifier, and their meaning are shown in Table 1. Note that a dual-thread system is used as an example, and that the problem solved by the present invention can be found in systems with two or more threads. The valid indicator and the thread identifier used for a dual-thread system are each one bit, which can have a value of 0 or 1. The valid indicator indicates whether the entry for the EA is valid, that is, whether it has a meaningful translation or not. The thread identifier identifies for which thread the entry was created. Thus, when a thread supplies an EA for translation, the following three conditions are checked; (i) there is an entry for the EA, (ii) the entry is valid and (iii) the thread identifier matches the identity of the thread requesting the translation, and the state of the EA matches the state portion of the entry. If one or more of these conditions is not met, a “miss” occurs. Only if all three conditions are satisfied is there a “hit” and the RA is retrieved.

Note that in the case where there is a valid EA to RA mapping in the ERAT table, but the thread identifier is not set for the thread requesting the EA lookup, a new entry will be added. This wastes valuable resources because (i) each thread will have its own entry in the ERAT table for the same valid EA to RA mapping, creating otherwise duplicate entries that differ only in terms of the thread identifier and (ii) a secondary translation must be performed on the EA to retrieve an RA, and the secondary translation operation is much slower than an ERAT table lookup.

For example, in the case where two threads share a memory segment, they may reference a specific memory address using the same EA, which translates into the same RA, but each thread will have a separate entry in the ERAT table.

This is wasteful because it creates duplicate entries for the same EA to RA mapping and causes a lengthy lookup using secondary translation for an EA to RA mapping already in the table. Therefore, there is a need for a more efficient method of using the ERAT table to translate an EA to an RA.

### SUMMARY OF THE INVENTION

The present invention provides a method and apparatus for efficiently translating an effective address (EA) to a real address (RA) in an Effective to Real Address Translation (ERAT) table, in a main processing unit (MPU) having two or more threads. A thread, using an EA, presents the EA for lookup in the ERAT table. The EA is compared to each entry in the ERAT table. If (i) the EA matches an entry in the ERAT table, (ii) a valid indicator in the matching entry indicates it is valid for other threads but not valid for the thread presenting the EA for lookup, and (iii) the information in the matching entry is correct for the EA presented for lookup, then the valid indicator is set to show that the matching entry is valid for the thread presenting the EA for lookup, in addition to the other threads.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram of how an effective address (EA) is translated into a real address (RA) using an Effective to Real Address Translation (ERAT) table;

FIG. 2 is a block diagram of combining two independent methods for increasing the efficiency of translating an EA to an RA using an ERAT table; and

FIG. 3 is a block diagram of a functional overview.

### DETAILED DESCRIPTION

In the following discussion, numerous specific details are set forth to provide a thorough understanding of the present invention. However, it will be apparent to those skilled in the art that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU regardless of whether the MPU is the sole computational element in the device or whether the MPU is sharing the computational load with other MPUs.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

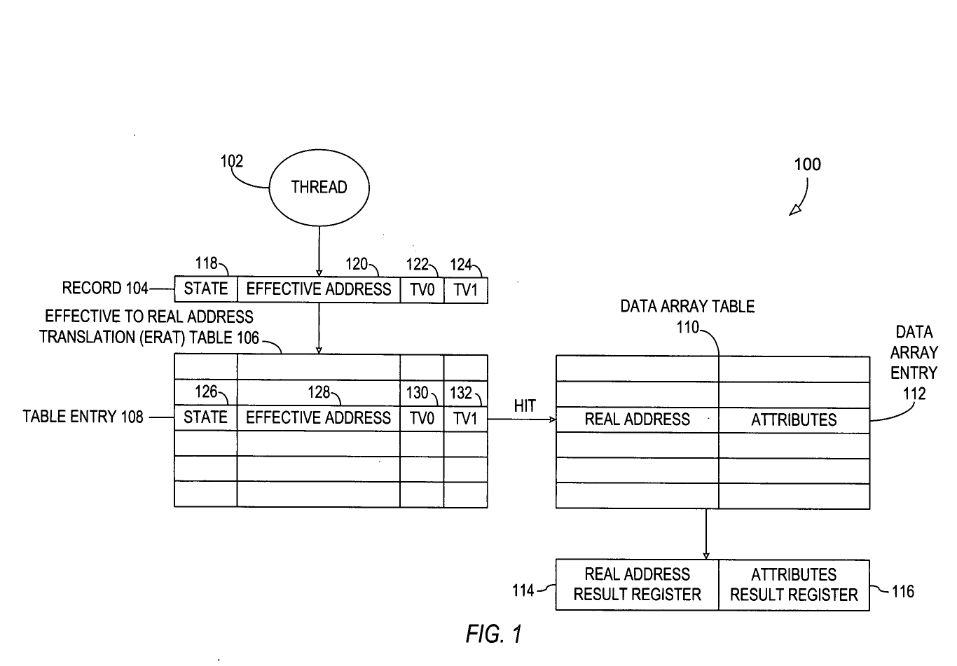

Referring to FIG. 1 of the drawings, the reference numeral 100 generally designates a block diagram of how an effective address is translated into a real address using an Effective to Real Address Translation (ERAT) table, embodying features of the present invention. The block diagram 100 comprises a thread 102, a record 104, an ERAT table 106, an ERAT table entry 108, a data array table 110, a data array entry 112, a real address (RA) result register 114 and an attributes result register 116. The record 104 comprises a state field 118, an effective address (EA) field 120, a thread valid 0 (tv0) field 122 and a thread valid 1 (tv1) field 124. The ERAT table entry 108 comprises a state entry 126, an EA entry 128, a tv0 entry 130 and a tv1 entry 132.

In FIG. 1, the present invention is used with a dual-thread MPU for illustration purposes. However, the present invention can be applied to MPUs with more than two threads, as is discussed later.

In ERAT table 106, tv0 entry 130 and tv1 entry 132 are used, as shown in Table 2, to indicate whether EA entry 128 is valid for thread 0, thread 1, threads 0 and 1, or whether it is invalid.

Note that for a dual-thread system, no additional bits or fields have been added to ERAT table entry 108. The thread identifier and valid indicator from the conventional system have been renamed tv0 and tv1, and are used in a different way to make more efficient use of the ERAT table 106.

For 2ⁿ threads, the conventional system typically uses n+1 bits. The method disclosed by the present invention, however, uses 2ⁿ bits for 2ⁿ threads, resulting in each ERAT table entry 108 being bigger and requiring more space for ERAT table 106 than in the conventional system. However, n is typically fairly small, and the slight increase in the size of ERAT table 106 is an acceptable design trade-off for the much more efficient use of ERAT table 106 that is enabled by the method disclosed by the present invention.

Note that a bit is one implementation of an indicator used to show whether an entry is valid for a thread, and that any type of indicator, such as a nibble, byte, word, etc., can be used to indicate that ERAT table entry 108 is valid for a particular thread.

TABLE 2

| Thread Valid 0 | Thread Valid 1 | Meaning |
|---|---|---|
| 0 | 0 | Invalid |
| 1 | 0 | Valid for thread 0 only |
| 0 | 1 | Valid for thread 1 only |
| 1 | 1 | Valid for threads 0 and 1 |

When thread 102 presents record 104 for lookup in ERAT table 106, an attempt is made to translate EA field 120 into an RA that will be output into RA result register 114 along with the attributes of the RA in attributes result register 116. The attributes result register 116 contains information about the RA in RA result register 114 such as whether it can be cached, whether it is data or program (executable) memory, which applications have access to it (privilege level), etc.

There are three possibilities for a lookup (read operation); (a) there is no entry for EA field 120 in ERAT table 106, (b) there is an entry for EA field 120 in ERAT table 106, the thread valid indicator is set for the thread making the lookup request, and state field 118 matches state entry 126 or (c) there is an entry for EA field 120 in ERAT table 106 but the thread valid indicator is not set for the thread requesting the lookup.

A “hit” is said to occur in the case of (b). In the case of (a) or (c), a “miss” is said to occur. State field 118 and state entry 126 contain information about the attributes of EA field 120 and EA entry 128, respectively, such as whether the address is read only, whether it is used by the operating system, etc. The state field 118 is presented for completeness, but is not relevant to the method disclosed by the present invention. The state field 118 is used in addition to the EA field 120 as part of the comparison against state entry 126 and EA entry 128 to determine a “hit” or “miss”. In the remainder of this discussion, for all cases where a match is described for EA field 120 and EA entry 128, it is assumed that a corresponding match occurs for state field 118 and state entry 126.

An example of (b) is when EA field 120 is equal to EA entry 128, state field 118 is equal to state entry 126, thread 102 is thread 0, tv0 field 122 is 1, tv1 field 124 can be 0 or 1, tv0 entry 130 is 1, and tv1 entry 132 can be 0 or 1. An example of (c) is when EA field 120 is equal to EA entry 128, state field 118 is equal to state entry 126, thread 102 is thread 0, tv0 field 122 is 1, tv1 field 124 can be 0 or 1, tv0 entry 130 is 0, and tv1 entry 132 is 1.

In the case of (a), if there is no entry for EA field 120 in ERAT table 106, that is, EA field 120 is compared to all entries in ERAT table 106 and for each entry, EA field 120 is not equal to EA entry 128, then a secondary translation is requested and a new entry is added to ERAT table 106 for EA field 120, with the thread valid indicator set for the thread making the lookup, and the state information set to the contents of state field 118. Thus, if thread 102 is thread 0, that is, tv0 122 is 1 and tv1 124 is 0, then tv0 entry 130 is set to 1, tv1 entry 132 is set to 0, and if thread 102 is thread 1, that is, tv0 122 is 0 and tv1 124 is 1, then tv1 entry 132 is set to 1 and tv0 entry 130 is set to 0.

In the case of (b), if there is an entry for EA field 120 in ERAT table 106, state field 118 is equal to state entry 126, and the thread valid indicator is set for the thread making the lookup, a hit occurs and the RA and its attributes are found in data array 110 and output to RA result register 114 and attributes result register 116, respectively. In this case, state field 118 and EA field 120 are compared to state entry 126 and EA entry 128, respectively, for all entries in ERAT table 106, and an entry is found where state field 118 is equal to state entry 126, EA field 120 is equal to EA entry 128, and if thread 102 is thread 0, that is, tv0 122 is 1, then tv0 entry 130 is 1, and if thread 102 is thread 1, that is, tv1 124 is 1, then tv1 entry 132 is 1.

In the case of (c), if there is an entry for EA field 120 in ERAT table 106 but the thread valid indicator is not set for the thread making the lookup, EA field 120 is sent to secondary translation and the result is compared to the information contained in data array 110. If there is a match, that is, the real address and attributes returned from secondary translation for EA field 120 match the real address and attributes returned from looking up EA entry 128 in data array 110, then the EA entry's thread valid indicator for the thread making the lookup is set, and a new entry is not created in ERAT table 106. That is, if thread 102 is thread 0, that is, tv0 field 122 is 1, and tv1 field 124 is 0, then tv0 entry 130 is set to 1 and if thread 102 is thread 1, that is, tv0 field 122 is 0 and tv1 field 124 is 1, then tv1 entry 132 is set to 1.

If there is no match between the result returned from secondary translation and the result of looking up EA entry 128 in data array 110, then a new entry for record 104 is added to ERAT table 106, showing the entry to be valid for the thread making the lookup, and a corresponding new data array entry 112 is added to data array table 110. That is, if thread 102 is thread 0, that is, tv0 122 is 1 and tv1 124 is 0, then tv0 entry 130 is set to 1 and tv1 entry 132 is set to 0, and if thread 102 is thread 1, that is, tv0 122 is 0 and tv1 124 is 1, then tv1 entry 132 is set to 1 and tv0 entry 130 is set to 0.

Thus in the case of (c), unlike in the conventional system, an entry 108 in ERAT table 106 that has an EA field 128 that translates to the same RA in RA result register 114 and the same attributes in attributes result register 116 is not duplicated in ERAT table 106 for a different thread; instead, the appropriate thread valid indicator tv0 or tv1 is set so that both are 1, indicating that entry 108 is valid for both threads.

Entry 108 in ERAT table 106 can become invalid under circumstances such as when a page in memory is swapped to disk, or when a thread dies, resulting in the EA to RA mapping no longer being valid for one or more threads. When this happens, the affected EA entry or entries must be invalidated for the affected threads. This is done by finding entry 108 in which EA field 128 matches an EA that has become invalid, and setting tv0 entry 130 to 0 if the EA to RA mapping is no longer valid for thread 0 and setting tv1 entry 132 to 0 if the EA to RA mapping is no longer valid for thread 1. If the EA to RA mapping is no longer valid for both thread 0 and thread 1, then both tv0 entry 120 and tv1 entry 132 are set to 0.

Thus there are two possibilities for an invalidate operation. If the EA to RA mapping is valid for some but not all threads, then a selective invalidate is done, and the appropriate thread valid indicators for ERAT table entry 108 are set to 0 for those threads for which the mapping is invalid. If the EA to mapping is invalid for all threads, then ERAT table entry 108 is invalidated by setting all the thread valid indicators to 0.

The next time a new entry must be created in ERAT table 106, that is, a write operation request, if there is an invalid entry in ERAT table 106, it is over-written. If there are no invalid entries in ERAT table 106, then a method well known in the art, such as least recently used (LRU), can be used to choose an entry 108 to over-write.

Note that the present invention can support more than two threads by adding a thread valid indicator in the ERAT table for every thread in the system. For example, in an MPU supporting a maximum of four threads, Table 3 shows how the present invention can be used to improve the efficiency of the ERAT table.

TABLE 3

| tv0 | tv1 | tv2 | tv3 | Meaning |
|---|---|---|---|---|
| 0 | 0 | 0 | 0 | Invalid |
| 1 | 0 | 0 | 0 | Valid for thread 0 only |
| 0 | 1 | 0 | 0 | Valid for thread 1 only |
| 0 | 0 | 1 | 0 | Valid for thread 2 only |
| 0 | 0 | 0 | 1 | Valid for thread 3 only |
| 1 | 1 | 0 | 0 | Valid for 0 and 1 only |
| 1 | 0 | 1 | 0 | Valid for 0 and 2 only |
| 1 | 0 | 0 | 1 | Valid for 0 and 3 only |
| 0 | 1 | 1 | 0 | Valid for 1 and 2 only |
| 0 | 1 | 0 | 1 | Valid for 1 and 3 only |
| 0 | 0 | 1 | 1 | Valid for 2 and 3 only |
| 1 | 1 | 1 | 0 | Valid for 0, 1 and 2 only |
| 1 | 1 | 0 | 1 | Valid for 0, 1 and 3 only |
| 1 | 0 | 1 | 1 | Valid for 0, 2 and 3 only |
| 0 | 1 | 1 | 1 | Valid for 1, 2, and 3 only |
| 1 | 1 | 1 | 1 | Valid for 0, 1, 2 and 3 |

As previously mentioned, as the number of threads supported by the MPU increase, so does the size of the ERAT table 106 and the efficiency of the present invention. The greatest increase in efficiency occurs when each thread has access to the same memory segment and is using the same set effective address mappings. In this scenario for a dual-read MPU, using the present invention results in a 50% reduction in ERAT table entries compared to the conventional system. In this scenario for a four-thread MPU, the present invention results in a 75% reduction, since in the conventional system each unique EA would take up four entries compared to one entry with the present invention. In this scenario for a 16-thread MPU, the present invention results in 93.75% fewer entries in the ERAT table.

Since ERAT table 106 is fixed in the number of entries it can contain, the present invention allows ERAT table 106 to contain more unique EAs, resulting in significantly faster EA to RA translation compared to the conventional system since fewer EAs need to be sent to secondary translation. Secondary translation is usually much slower than an ERAT table 106 lookup. Typically, an ERAT table 106 lookup may take 2 machine cycles, while a secondary translation may take 10 machine cycles or more, depending on how many levels of cache the “miss” occurs in.

Another method of improving the efficiency of EA to RA translation using ERAT table 106 is also disclosed by the present invention, and relates to case (a) discussed above, when there is no entry for EA field 120 in ERAT table 106. In case (a), EA field 120 is compared to all entries in ERAT table 106 and for each entry, EA field 120 is not equal to EA entry 128, so a secondary translation is requested, and a new entry is added to ERAT table 106 for EA field 120.

In the previously described method, the thread valid indicator is set only for thread 102. If thread 102 is thread 0, then tv0 entry 130 is set to 1 and tv1 entry 132 is set to 0. If thread 102 is thread 1, then tv0 entry 130 is set to 0 and tv1 entry 132 is set to 1.

However, if a resource manager, such as an operating system, is aware that a specific memory segment is shared by more than one thread, and is also aware of the identity of those threads sharing that memory segment, then in case (a) the thread valid indicator can be set for all threads that share the memory segment addressed by EA 120 the first time an entry for EA 120 is created in ERAT table 106.

Thus in this method, if thread 0 and thread 1 share the memory segment referenced by EA 120, a new entry is added to ERAT table 106 with tv0 entry 130 set to 1 and tv1 entry 132 set to 1. This method avoids a secondary translation when the other thread subsequently presents the same EA for lookup, as would occur in the previously described method. The fact that a memory segment is shared by more than one thread is typically reported using an indicator returned from secondary translation, and can be set by the resource manager.

Note that the two methods disclosed above are independent. Both methods disclosed above make use of a thread valid indicator for each thread, instead of the conventional method of having a single valid indicator and a single thread identifier. Each method can be used by itself to improve the efficiency of an EA to RA translation using ERAT table 106, or they can be combined together for greater efficiency.

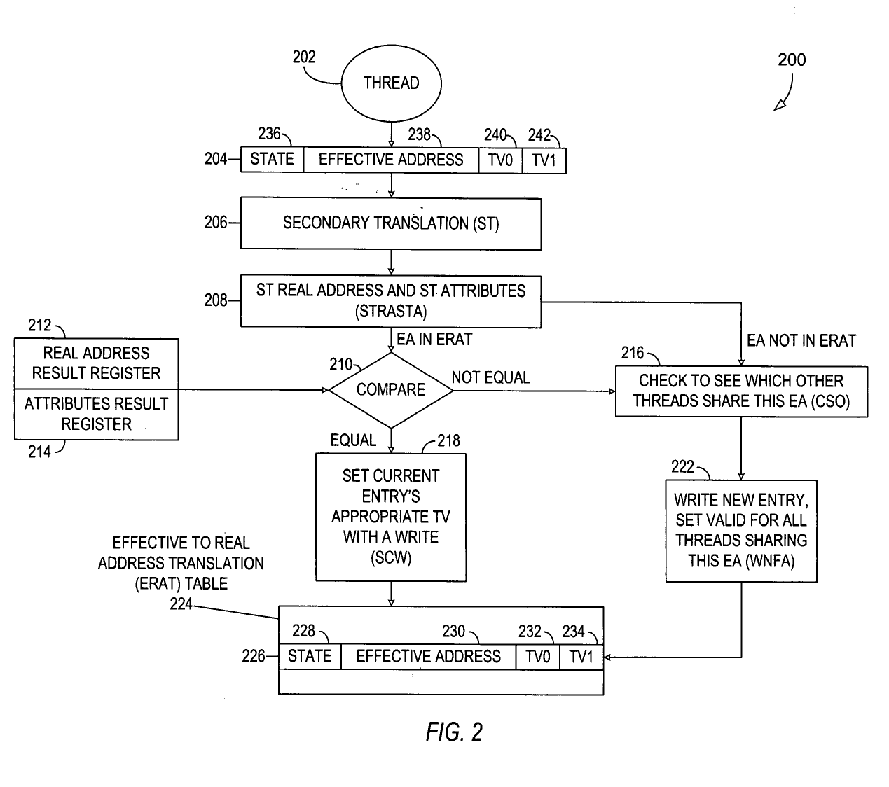

Now referring to FIG. 2, the reference numeral 200 generally designates a block diagram of combining two independent methods for increasing the efficiency of translating an EA to an RA using an ERAT table, embodying features of the present invention.

The block diagram 200 comprises a thread 202, a record 204, a secondary translation (ST) 206, an ST real address and ST attributes (STRASTA) 208, a real address result register (RARR) 212, an attributes result register (ARR) 214, a compare operation 210, a check-if-shared operation (CSO) 216, a set current write (SCW) operation 218, a write new for all (WNFA) operation 222, an Effective to Real Address Translation (ERAT) table 224, and an ERAT table entry 226. Record 204 comprises a state field 236, an effective address (EA) field 238, thread valid 0 (tv0) field 240 and thread valid 1 (tv1) field 242. ERAT table entry 226 comprises state entry 228, EA entry 230, tv0 entry 232 and tv1 entry 234.

In FIG. 2, a dual-thread MPU is used as an example. It should be noted however, that as previously discussed, the present invention can be extended to support more than two threads.

Note that real address result register 212 and attributes result register 214 refer to the same registers referenced in FIG. 1 as real address result register 114 and attributes result register 116, respectively.

When thread 202 presents record 204 for lookup, a “miss” occurs when there is no ERAT table entry 226 for EA field 238 in ERAT table 224, or when EA field 238 matches EA entry 230 but the thread valid indicator is not set for the thread requesting the lookup.

When a miss occurs, record 204 is sent to secondary translation 206 where the real address along with the associated attributes for EA 238 are found and output as STRASTA 208. If the miss occurred because there is no ERAT table entry 226 for EA field 238 in ERAT table 224, then CSO 216 is performed.

In CSO 216, a check is done to see if EA field 238 is shared by more than one thread and this information is used to perform WNFA operation 222. In WNFA operation 222, a new ERAT table entry 226 is written in ERAT table 224, with state entry 228 set to state field 236, EA entry 230 set to EA field 238, and the thread valid indicators set based on the information provided by CSO operation 216 so that ERAT table entry 226 is indicated as valid for all threads sharing the EA.

In the dual-thread example, if CSO 216 determines that both thread 0 and thread 1 share the EA contained in EA field 238, then both tv0 entry 232 and tv1 entry 234 are set to 1. If CSO 216 determines that the EA in EA field 238 is not shared, then tv0 entry 232 is set to 1 and tv1 entry 234 is set to 0, or tv1 entry 234 is set to 1 and tv0 entry 232 is set to 0, depending on whether thread 202 is thread 0 or 1, respectively.

If the miss occurred because an ERAT table entry 226 was found with EA field 238 equal to EA entry 230, but ERAT table entry 226 is not valid for thread 202, then compare operation 210 is performed to ensure that ERAT table entry 226 is correct for EA field 238. In the dual-thread case, this means that if tv0 entry 232 or tv1 entry 234 was not set for the identity of thread 202, then compare operation 210 is performed. That is, if EA field 238 is equal to EA entry 230, and if thread 202 is thread 0, then tv0 entry 232 is 0 and tv1 entry 234 is 1 (valid for thread 1 only), or if thread 202 is thread 1, then tv0 entry 232 is 1 and tv1 entry 234 is 0 (valid for thread 0 only), then compare operation 210 is performed.

In compare operation 210, STRASTA 208 is compared to RARR 212 and ARR 214, and if they are found to be equal, then SCW operation 218 is performed. RARR 212 and ARR 214 are the RA and attributes resulting from a data array lookup, as previously discussed in the description of FIG. 1.

In SCW operation 218, ERAT table entry 226 is modified by setting tv0 entry 232 to 1 or tv1 entry 234 to 1, depending on whether the identity of thread 202 is thread 0 or thread 1, respectively.

If compare operation 210 finds STRASTA 208 is not equal to RARR 212 and ARR 214, a CSO operation 216 is performed, followed by a WNFA operation 222. CSO operation 216 is performed to determine which other threads share EA field 238, and then WNFA operation 222 is performed to write a new ERAT table entry 226, with the thread valid indicators set to indicate that ERAT table entry 226 is valid for all threads sharing EA field 238.

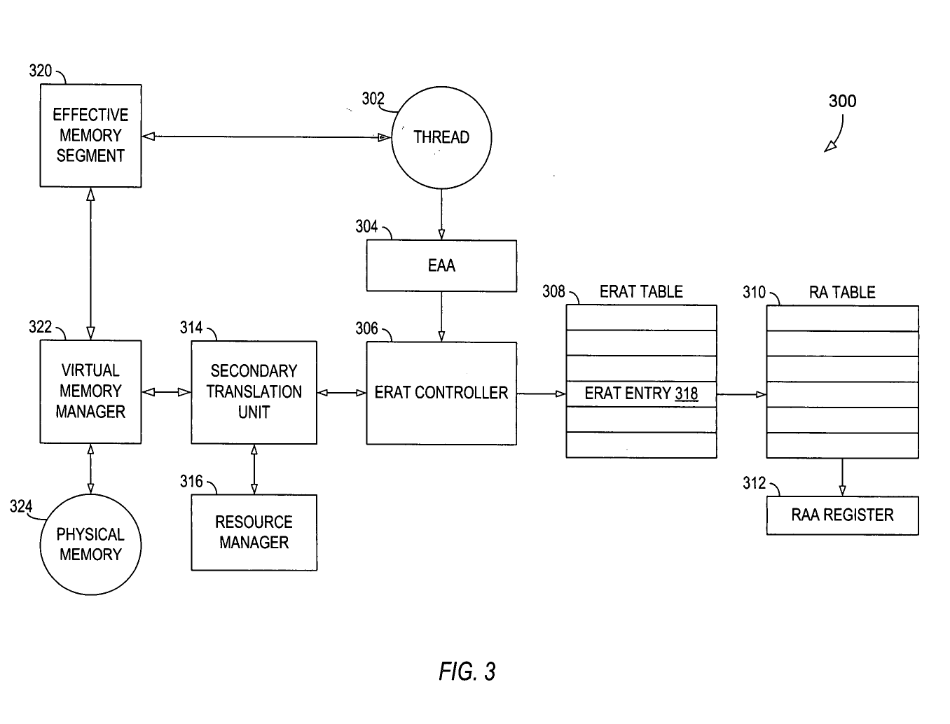

Now referring to FIG. 3, the reference numeral 300 generally designates a block diagram of a functional overview, embodying features of the present invention.

The block diagram 300 comprises a thread 302, an EA and attributes (EAA) record 304, ERAT controller 306, ERAT table 308, RA table 310, RA and attributes register (RAA) 312, secondary translation unit (STU) 314, resource manager 316, ERAT entry 318, effective memory segment 320, virtual memory manager 322, and physical memory 324.

ERAT controller 306 performs various operations on ERAT table 308, including translating an EA to an RA using ERAT table 308, modifying existing ERAT table entries, writing new ERAT table entries and invalidating ERAT table entries. ERAT controller 306 may be implemented using any combination of software, firmware or hardware.

The description of FIG. 3 is meant as a high-level, functional overview of the operations previously discussed, and all previously discussed details are to be understood as being present, even if they are not explicitly stated.

When thread 302 presents an EAA record 304 and requests that the EA be translated into an RA, ERAT controller 306 does a comparison with all the entries in ERAT table 308, and if a matching entry is found, looks up the corresponding RA in RA table 310, and has the resulting RA and its attributes output to RAA register 312.

When thread 302 presents an EAA record 304 and requests the contents of EAA record 304 be written as a new entry in ERAT table 308, ERAT controller 306 sends the contents of EAA record 304 to STU 314, and upon receiving the resulting RA, checks to see if there is an entry in ERAT table 308 that refers to the same EAA record. This is done by asking STU 314 to determine the RA for EAA 304. STU 314 then determines the RA from virtual memory manager 322 and returns it to ERAT controller 306 which compares it to the RA obtained from RA table 310. If the RA from STU 314 matches the RA in RA table 310, ERAT entry 318 can be reused.

If an ERAT table entry 318 in ERAT table 308 can be reused, ERAT controller 306 does so by indicating that entry 318 is valid for thread 302 as well as the threads for which it is currently valid. If there is no entry in ERAT table 308 that can be reused, a new ERAT table entry 318 is written, and the entry is set as valid for thread 302.

If there is a resource manager 316 intelligent enough to keep track of all threads sharing a memory segment using the same EA, then prior to writing the new entry, ERAT controller 306 requests and obtains this information from STU 314, which in turn queries resource manager 316. The new ERAT table entry 318 is then set as valid for all threads with access to the memory segment using the EA.

When an EA is no longer valid for one or more threads, resource manager 316 sends an invalidate command to ERAT controller 306. ERAT controller 306 then finds the appropriate ERAT table entry 318, and sets the entry as not valid for the appropriate threads.

It will be understood from the foregoing description that various modifications and changes can be made in the preferred embodiment of the present invention without departing from its true spirit. This description is intended for purposes of illustration only and should not be construed in a limiting sense. The scope of this invention should be limited only by the language of the following claims.

1. A method of efficiently storing an effective address (EA) used by a thread in an Effective to Real Address Translation (ERAT) table, in a main processing unit (MPU) having two or more threads, the method comprising the steps of:
defining a thread valid indicator for each thread in the MPU;
storing an EA using one ERAT table entry; and
setting a thread valid indicator in the ERAT table entry for each thread using the EA to refer to the same RA.

2. The method of claim 1, further comprising translating the effective address (EA) to a real address (RA) using an Effective to Real Address Translation (ERAT) table.

3. The method of claim 2, further comprising:
determining whether the EA matches an ERAT table entry;
upon determining that the EA matches an ERAT table entry, determining whether the matching entry is marked valid for this thread;
upon determining that the matching entry is marked valid for this thread, looking up the corresponding RA in the data array table and outputting the RA;
upon determining that the matching entry is not marked valid for this thread but is marked valid for other threads, determining whether the information in the matching entry is correct for this thread;
upon determining that the information in the matching entry is correct for this thread, setting a valid indicator marking the entry as valid for this thread also;
upon determining that the information in the matching entry is not correct for this thread, or that the EA does not match any ERAT table entry, writing a new ERAT table entry for the EA and marking it valid for this thread.

4. The method of claim 3, wherein when writing a new ERAT table entry for the EA, the entry's thread valid indicators are set to show the entry is valid for all threads using the EA to refer to the RA.

5. The method of claim 1, further comprising invalidating the EA entry in the ERAT table.

6. The method of claim 5, further comprising:
determining the threads for which the EA entry is no longer valid; and
setting the thread valid indicators, for those threads for which the EA entry is no longer valid, to invalid in the EA entry.

7. The method of claim 1, further comprising writing the EA to the ERAT table.

8. The method of claim 7, further comprising:
presenting the EA used by the thread;
determining that the EA does not match any entry in the ERAT table;
retrieving an RA for the EA using a secondary translation;
writing a new entry containing the EA; and
setting the entry's thread valid indicator to show the EA entry is valid for the thread.

9. The method of claim 8, wherein the entry's thread valid indicators are set to show the entry is valid for all threads using the EA to refer to the RA.

10. An apparatus for efficiently storing an effective address (EA) used by a thread in an Effective to Real Address Translation (ERAT) table, in a main processing unit (MPU) having two or more threads, the apparatus comprising:
means for defining a thread valid indicator for each thread in the MPU;
means for storing an EA using one ERAT table entry; and
means for setting a thread valid indicator in the ERAT table entry for each thread using the EA to refer to the same RA.

11. The apparatus of claim 10, further comprising translating the EA to an RA using an ERAT table.

12. The apparatus of claim 11, further comprising:
means for determining whether the EA matches an ERAT table entry;
upon determining that the EA matches an ERAT table entry, means for determining whether the matching entry is marked valid for this thread;
upon determining that the matching entry is marked valid for this thread, means for looking up the corresponding RA in the data array table and means for outputting the RA;
upon determining that the matching entry is not marked valid for this thread but is marked valid for other threads, means for determining whether the information in the matching entry is correct for this thread;
upon determining that the information in the matching entry is correct for this thread, means for setting a valid indicator marking the entry as valid for this thread also;
upon determining that the information in the matching entry is not correct for this thread, or that the EA does not match any ERAT table entry, means for writing a new ERAT table entry for the EA and means for marking it valid for this thread.

13. The apparatus of claim 12, wherein when writing a new ERAT table entry for the EA, the entry's thread valid indicators are set to show the entry is valid for all threads using the EA to refer to the RA.

14. The apparatus of claim 10, further comprising invalidating the EA entry in the ERAT table.

15. The apparatus of claim 14, further comprising:
means for determining the threads for which the EA entry is no longer valid; and
means for setting the thread valid indicators, for those threads for which the EA entry is no longer valid, to invalid in the EA entry.

16. The apparatus of claim 10, further comprising writing the EA to the ERAT table.

17. The apparatus of claim 16, further comprising:
means for presenting the EA used by the thread;
means for determining that the EA does not match any entry in the ERAT table;
means for retrieving an RA for the EA using a secondary translation;
means for writing a new entry containing the EA; and
means for setting the entry's thread valid indicator to show the EA entry is valid for the thread.

18. The apparatus of claim 17, wherein the entry's thread valid indicators are set to show the entry is valid for all threads using the EA to refer to the RA.

19. A computer program product for efficiently storing an effective address (EA) used by a thread in an Effective to Real Address Translation (ERAT) table, in a main processing unit (MPU) having two or more threads, the computer program product having a medium with a computer program embodied thereon, the computer program comprising:
computer program code for defining a thread valid indicator for each thread in the MPU;
computer program code for storing an EA using one ERAT table entry; and
computer program code for setting a thread valid indicator in the ERAT table entry for each thread using the EA to refer to the same RA.

20. The computer program product of claim 19, further comprising translating the EA to an RA using an ERAT table.

21. The computer program product of claim 20, further comprising:
computer program code for determining whether the EA matches an ERAT table entry;
upon determining that the EA matches an ERAT table entry, computer program code for determining whether the matching entry is marked valid for this thread;
upon determining that the matching entry is marked valid for this thread, computer program code for looking up the corresponding RA in the data array table and computer code for outputting the RA;
upon determining that the matching entry is not marked valid for this thread but is marked valid for other threads, computer program code for determining whether the information in the matching entry is correct for this thread;
upon determining that the information in the matching entry is correct for this thread, computer program code for setting a valid indicator marking the entry as valid for this thread also;
upon determining that the information in the matching entry is not correct for this thread, or that the EA does not match any ERAT table entry, computer program code for writing a new ERAT table entry for the EA and computer program code for marking it valid for this thread.

22. The computer program product of claim 21, wherein when writing a new ERAT table entry for the EA, the entry's thread valid indicators are set to show the entry is valid for all threads using the EA to refer to the RA.

23. The computer program product of claim 19, further comprising invalidating the EA entry in the ERAT table.

24. The computer program product of claim 23, further comprising:
computer program code for determining the threads for which the EA entry is no longer valid; and
computer program code for setting the thread valid indicators, for those threads for which the EA entry is no longer valid, to invalid in the EA entry.

25. The computer program product of claim 19, further comprising writing the EA to the ERAT table.

26. The computer program product of claim 25, further comprising:
computer program code for presenting the EA used by the thread;
computer program code for determining that the EA does not match any entry in the ERAT table;
computer program code for retrieving an RA for the EA using a secondary translation;
computer program code for writing a new entry containing the EA; and
computer program code for setting the entry's thread valid indicator to show the EA entry is valid for the thread.

27. The computer program product of claim 26, wherein the entry's thread valid indicators are set to show the entry is valid for all threads using the EA to refer to the RA.
